(19) United States
(12) Patent Application Publication
(10) Pub. No.: US 2026/0074792 A1
(43) Pub. Date: Mar. 12, 2026

(54) LOW COMPLEXITY AND LOW LATENCY IMPLEMENTATION FOR CELLULAR FRONTHAULING

(71) Applicant: Microsoft Technology Licensing, LLC, Redmond, WA (US)

(72) Inventor: Arsalan SALJOGHEI, Southampton (GB)

(73) Assignee: Microsoft Technology Licensing, LLC, Redmond, WA (US)

(21) Appl. No.: 18/827,372

(22) Filed: Sep. 6, 2024

(51) Int. Cl. H04B 10/2575; H04L 7/00; H04W 88/08

(52) U.S. Cl. CPC H04B 10/25759; H04L 7/0008; H04W 88/08

(57) ABSTRACT

Systems and methods provide for a low complexity and low latency implementation for cellular fronthauling. At a baseband unit (“BBU”), data packets received from a data network are converted into analog data signals, which are in turn converted into analog optical signals that are optically amplified and sent over a hollow core fiber (“HCF”)-based fronthaul link(s) to a remote radio unit(s) (“RRU(s)”). At the RRU(s), the analog optical signals are converted into analog data signals that are sent over the air as radio frequency (“RF”) signals via an antenna(s). In some cases, the analog data signals are filtered and amplified prior to RF signal transmission. RF signals that are received, via antennas, at an RRU are conversely filtered and converted into analog optical signals, transmitted over the HCF-based fronthaul link(s) to the BBU, where the analog optical signals are converted into data packets for transmission over the data network.

### BACKGROUND

As cellular networks advance into the next generation of wireless deployment beyond 4G and 5G implementations, radio access network (“RAN”) technology and/or cloud radio access network (“C-RAN”) technology can become more complex and costly. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for a low complexity and low latency implementation for cellular fronthauling. At a baseband unit (“BBU”), data packets received from a data network are converted into analog data signals, which are in turn converted into analog optical signals that are optically amplified and sent over a hollow core fiber (“HCF”)-based fronthaul link(s) to a remote radio unit(s) (“RRU(s)”). At the RRU(s), the analog optical signals are converted into analog data signals that are sent over the air as radio frequency (“RF”) signals via an antenna(s). In some cases, the analog data signals are filtered and amplified prior to transmission as RF signals. RF signals that are received at uplink, via antennas, at an RRU are conversely filtered and converted into analog optical signals, transmitted over the HCF-based fronthaul link(s) to the BBU, where the analog optical signals are converted into data packets for transmission over the data network. In this manner, digitization of the optical data signal and back to analog after transmission over the fronthaul link is obviated, leading to lower complexity of hardware and software components for implementing such conversion (which is required in conventional solid core fiber-based RAN and/or C-RAN implementations). High-power or high intensity optical signals can also be sent over the HCF-based fronthaul link(s) compared with solid core fiber-based fronthaul links, which are susceptible to chromatic dispersion and nonlinearities due to interaction between high intensity propagating optical signals and silica in the solid core fibers. This is due to the structure of HCFs minimizing Kerr effects, thus minimizing chromatic dispersion and nonlinearities.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing improved cellular fronthauling.

FIGS. 2A-2C depict various example sets of components that are used, and an example series of optical signals that is sent as output of one of a plurality of multiplexers from a BBU to an RRU(s), when implementing improved cellular fronthauling.

FIG. 2D depicts an example set of components that may be used for sending optical signals from an RRU to a BBU when implementing improved cellular fronthauling.

FIG. 3 depicts an example method for sending data from a BBU to an RRU when implementing improved cellular fronthauling.

FIG. 4 depicts an example method for sending data from an RRU to a BBU when implementing improved cellular fronthauling.

FIG. 5 depicts a block diagram illustrating example physical components of a computing device with which aspects of the technology may be practiced.

### DETAILED DESCRIPTION OF CERTAIN EMBODIMENTS

As briefly discussed above, cellular networks are advancing into the next generation of wireless deployment beyond 4G and 5G implementations. There is also an increased demand for greater cellular bandwidths required by media rich cellular applications and higher numbers of cellular devices within a geographical region with the advancing cellular network technologies. To address the increased demand for greater cellular bandwidths, C-RAN and open RAN (“O-RAN”) structures were proposed for 4G and beyond infrastructures. These schemes allow for dense packing of many base stations, each with smaller geographical coverage, which allows for sharing of available capacity with a smaller subset of users and hence higher data rates per user. One of the major drivers for the C-RAN scheme (or the O-RAN scheme) is that it allows for centralization of the BBU within a central office. In conventional wireless implementations, the BBU was co-localized with the RRUs (also referred to as remote radio heads (“RRHs”)), which led to high costs, high power consumption, and high-power computations. The centralization of BBUs allows for resource sharing and better coordination between RRUs, which, as a result, reduces operational costs. The link between the central office, which houses the BBUs, to the RRUs is called the fronthaul, and optical fibers are used as fronthaul links for this part of the network. The fronthaul links are responsible for carrying the data signals to the RRUs, where the data signals are converted to RF signals, amplified, and radiated to the air via an antenna. In traditional systems, the fronthaul links would have been made up of lossy coaxial cables of 10s of meters in length, delivering high power microwave signals to the transmitter antennas. In conventional C-RAN (or O-RAN) infrastructures, the fronthaul links are made up of standard single mode solid core fibers of up to 10s of kilometers in length, carrying a digitized version of the microwave signal from the BBUs to the RRUs.

Although C-RAN (or O-RAN) has managed to provide many superior features over other conventional systems for 4G and 5G systems, it still has many complexities, resulting in ever higher cellular data rates as cellular technology approaches 5G and beyond. One of the drawbacks of conventional C-RAN (or O-RAN) is the fact that analog microwave signals need to be digitized for transport over fronthaul links, because normal solid core optical fibers otherwise induce distortions such as fading effects and the generation of spurious signals that are detrimental to quality of the microwave signals. The digitization process involves a significant multiplication in the effective payload data rates, which can sometimes exceed 10 times. This multiplication, for certain situations, can lead to the requirement of single base stations needing fiber delivery of data rates on the order of 10s to 100s of Terabits per second (Tbps) and, in next generation systems, this can even increase further to potentially Petabits per second (Pbps) data rates. Considering that more and more base stations will need to be deployed in a single geographical region to accommodate the growing demand for higher data rates, and considering the extremely large capacities required to be transported over optical fronthaul links, such a structure becomes unsustainable.

Given the possibilities for even higher wireless capacity, the cellular industry is gravitating toward pushing the operational frequencies towards the millimeter wave (“mmWave”) band for 5G and beyond. However, the conventional C-RAN (or O-RAN) structure represents a significant roadblock for achieving this goal, as the digitization approach will become even more complex, more data hungry, and more power hungry, and the RRUs will need to be even more complex. Further, the digitization process and the conversion back to the analog domain at the RRUs also requires a tremendous level of complexity and power consumption, especially at the RRUs, which should be as cost effective as possible. Moreover, base stations covering a specific region need to have constant communication and cooperation with one another and need to adhere to very tight latency and synchronization requirements between themselves and the central office. These requirements increase further as the cellular technology approaches 5G and beyond.

The present technology provides for improved cellular fronthauling by utilizing a low complexity and low latency implementation. In particular, the present technology uses HCF cables for fronthaul links, which leads to a significant reduction in complexity and minimizes many requirements of conventional solid core fiber-based fronthaul implementations. Importantly, the need for digitization and conversion back to the analog domain can be obviated with the HCF-based fronthaul implementation, because the HCF cables are capable of carrying analog optical data signals without inducing distortions such as fading effects nor generating spurious signals. Without the need to digitize the optical signals, the HCF-based implementation, as described herein, leads to a reduction in spectral capacities and a reduction in data rates compared with solid core-based implementations. The integration of HCF and removal of digitization hardware further relaxes latency constraints imposed on fronthaul links, resulting in a single BBU being capable of covering RRUs in a wider geographical region, which in turn leads to greater resource sharing and improved synchronization among RRUs. The resilience of HCF, in such RAN-based infrastructure, to temperature variations that would otherwise induce delay variations also paves the way for synchronization of RRUs by feeding a common clock signal to all RRUs through the optical link. In contrast, for solid core fibers, due to temperature variations and stresses, delay in fibers can change with time differently from other fibers, due to susceptibility of glass cores of the solid core fibers to stretching, resulting in changes in refractive index of the solid core fibers over time, thus making synchronization difficult. Another feature of the HCF implementation is that the high resilience of HCF towards nonlinearities allows the generated optical signals to be amplified to very high-power or very high intensity levels, which are not possible with normal solid-core fiber solutions. This means that the demand for a high level of RF amplification required at the RRU side for wireless transmission can be reduced or skipped, particularly if high power photodetectors are employed, as the amplification is achieved in the optical domain at the BBU side.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

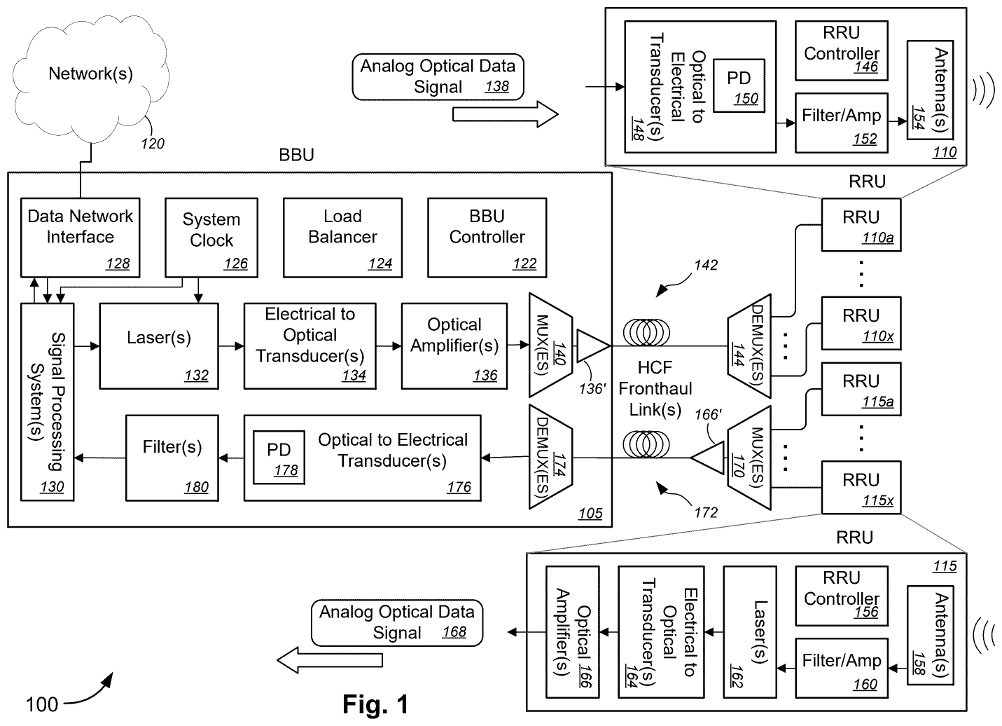

Turning to the embodiments as illustrated by the drawings, FIGS. 1-5 illustrate some of the features of methods, systems, and apparatuses for implementing cellular fronthauling, and, more particularly, to methods, systems, and apparatuses for providing a low complexity and low latency implementation for cellular fronthauling, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example system 100 for implementing improved cellular fronthauling. System 100 includes a BBU 105, RRUs 110a-110x and 115a-115x (collectively, “RRUs 110 and/or 115”; also referred to as a “RRHs 110 and/or 115”), and a network(s) 120. Network(s) 120 may each include at least one of a distributed computing network, such as the Internet, a private network, a commercial network, or a cloud network, and/or the like. In examples, BBU 105 includes a BBU controller 122, a load balancer 124, a system clock 126, a data network interface 128, a signal processing system(s) 130, a laser(s) 132, an electrical to optical (“E/O”) transducer(s) 134, an optical amplifier(s) 136 or 136′, a multiplexer(s) (“mux(es)”) 140, a demultiplexer(s) (“demux(es)”) 174, an optical to electrical (“O/E”) transducer(s) 176 (in some cases, including a photodetector(s) 178), and/or a filter(s) 180. System 100 further includes HCF fronthaul links 142 and 172, demux(es) 144, and mux(es) 170. In examples, each, or at least one, of RRUs 110a-110x includes an RRU controller 146, an O/E transducer(s) 148 (in some cases, including a photodetector(s) 150), a filter and/or amplifier 152, and/or an antenna(s) 154. In some examples, each, or at least one, of RRUs 115a-115x includes an RRU controller 156, an antenna(s) 158, a filter and/or amplifier 160, a laser(s) 162, an E/O transducer(s) 164, and/or an optical amplifier(s) 166 or 166′. In examples, optical amplification by optical amplifier(s) 136 or 136′ and/or 166 or 166′ is either a solid state-based amplification or a fiber-based amplification, where the amplifiers 136 or 136′ and 166 or 166′ are capable of outputting at or above 2.5 W and above with low levels of amplified spontaneous emissions (“ASE”), which are effectively noise exacerbated or amplified by the amplification process. Although FIG. 1 depicts antennas 154 and 158 as being integrated with corresponding RRUs 110 and 115, respectively, antennas 154 and 158 may be external to, yet communicatively coupled with, their respective RRUs 110 and 115. In an example, an RRU 110 and an RRU 115 are separate RRUs, one for RF signal transmission and the other for RF signal reception. In another example, an RRU 110 and an RRU 115 are part of a single RRU that is configured to handle both RF signal transmission and RF signal reception.

In some examples, the BBU 105 is configured to process baseband frequencies, which are frequencies of transmission signals that have not (or have not yet) been modulated to higher frequencies. In examples, the BBU 105 is further configured:
(1) to serve as a centralized hub of a base station that processes uplink and downlink data traffic with one or more RRUs with which the BBU is communicatively coupled;
(2) to control RRU functionality; and/or
(3) to collaborate with RF processing units (e.g., RRU controller(s) 146 and 156) to manage RAN or C-RAN (or O-RAN) operations.

In some examples, RRU(s) 110 and/or 115 is configured to extend coverage of the BBU 105. In examples, the RRU(s) 110 is configured to convert optical data signals from the BBU 105 into RF data signals for transmission using antenna(s) 154, and the RRU(s) 115 is configured to receive RF data signals using antenna(s) 158 and to convert the RF data signals into optical data signals for transmission to the BBU 105.

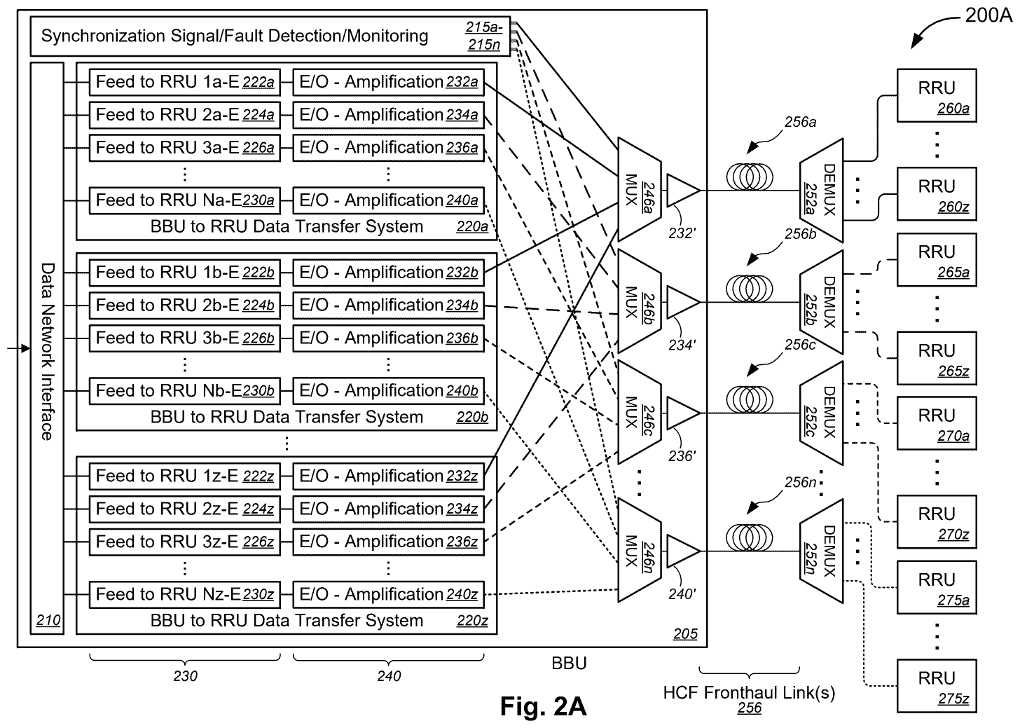

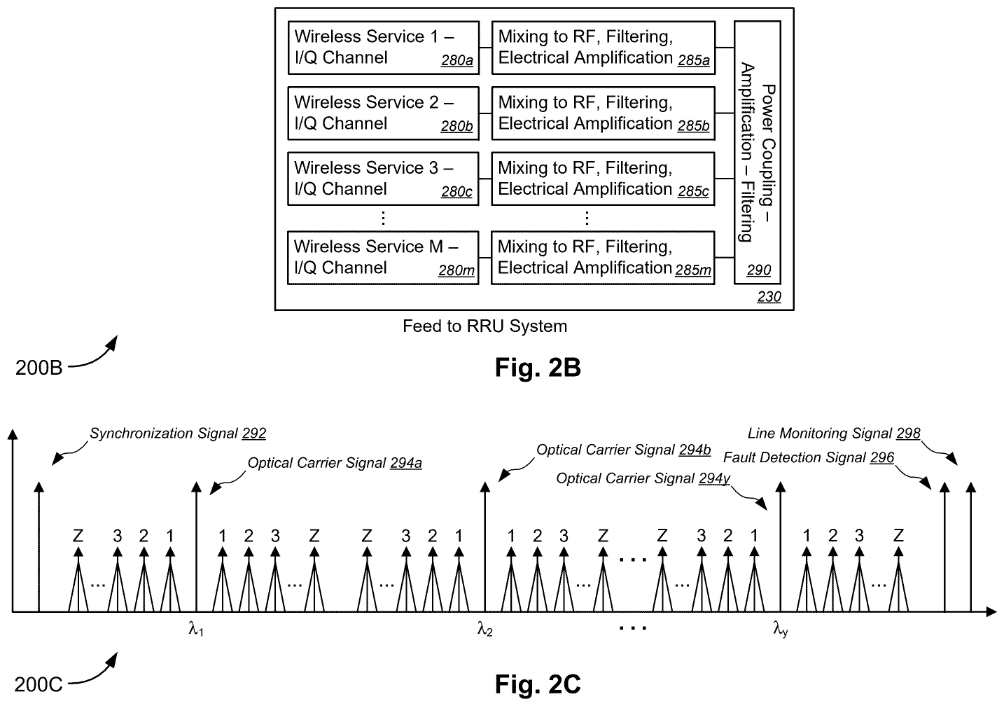

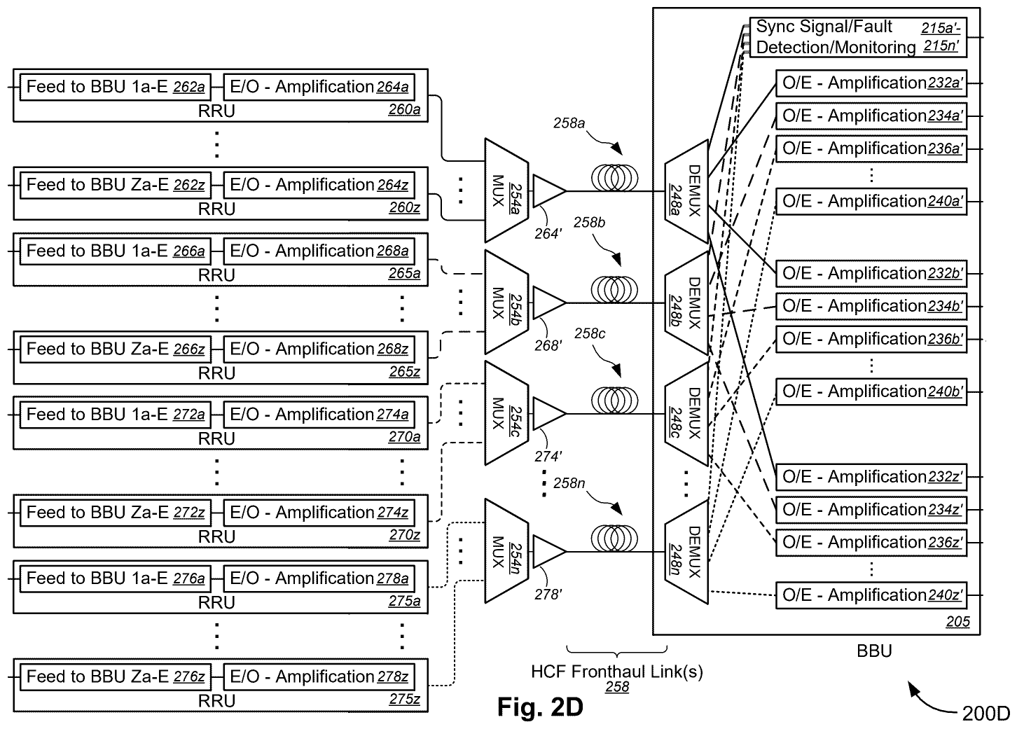

In examples, the BBU controller 122 is configured to control the operations of the BBU 105 and to control various components of the BBU 105, while RRU controller 146 is configured to control operations of RRU 110 and to control various components of RRU 110, and RRU controller 156 is configured to control operations of RRU 115 and to control various components of RRU 115. The load balancer 124 is configured to evenly distribute network data traffic from network(s) 120 across the various RRUs 110a-110x and 115a-115x, based at least in part on destination. The load balancer 124 is also configured to send the network data traffic to the correct RRU(s) located at or near where end users reside. The system clock 126 is configured to output a common clock signal that is used by the BBU 105 to synchronize local clocks of the RRUs 110a-110x and 115a-115x. Distribution of the network data traffic and the common clock signal is illustrated in FIG. 2A by the lined connections into the muxes 246a-246n, which couple to RRUs 260a-260z, 265a-265z, 270a-270z, and 275a-275z via HCF fronthaul links 256a-256n and via demuxes 252a-252n.

Turning back to FIG. 1, the data network interface 128 is configured to receive data from network(s) 120 for RF transmission via RRU(s) 110a-110x and 115a-115x, and to send data received from the RRU(s) 110a-110x and 115a-115x to network(s) 120. The signal processing system(s) 130 is configured to convert data packets from the network(s) 120 into analog data signals (in their native wireless format), and to convert analog data signals into data packets for sending to the network(s) 120 via data network interface 128. E/O transducers 134 and 164 convert data signals (in this case, analog data signals) into optical data signals (in this case, analog optical data signals), while O/E transducers 148 and 176 convert optical data signals (in this case, analog optical data signals) into data signals (in this case, analog data signals). Lasers 132 and 162 transmit or emit optical data signals, while photodetectors 150 and 178 detect or receive optical data signals. Optical amplifiers 136 or 136′ and 166 or 166′ perform optical amplification of optical data signals. Filter and/or amplifier 152 filters data signals and amplifies the filtered data signals for transmission as RF data signals by antenna(s) 154. Filter and/or amplifier 160 filters and/or amplifies RF data signals received from antenna(s) 158.

In some examples, muxes 140 and 170 multiplex multiple optical data signals for transmission over HCF fronthaul links 142 and 172, respectively, to demuxes 144 and 174, respectively, which demultiplex the multiplexed optical data signals. The HCF fronthaul links 142 and 172 each includes HCF cables that each includes a plurality of nested hollow tubes formed on an inner surface of that cable that extends parallel to an axis of the cable and that, in some cases, is equidistantly spaced apart along a circumference of the inner surface of the cable.

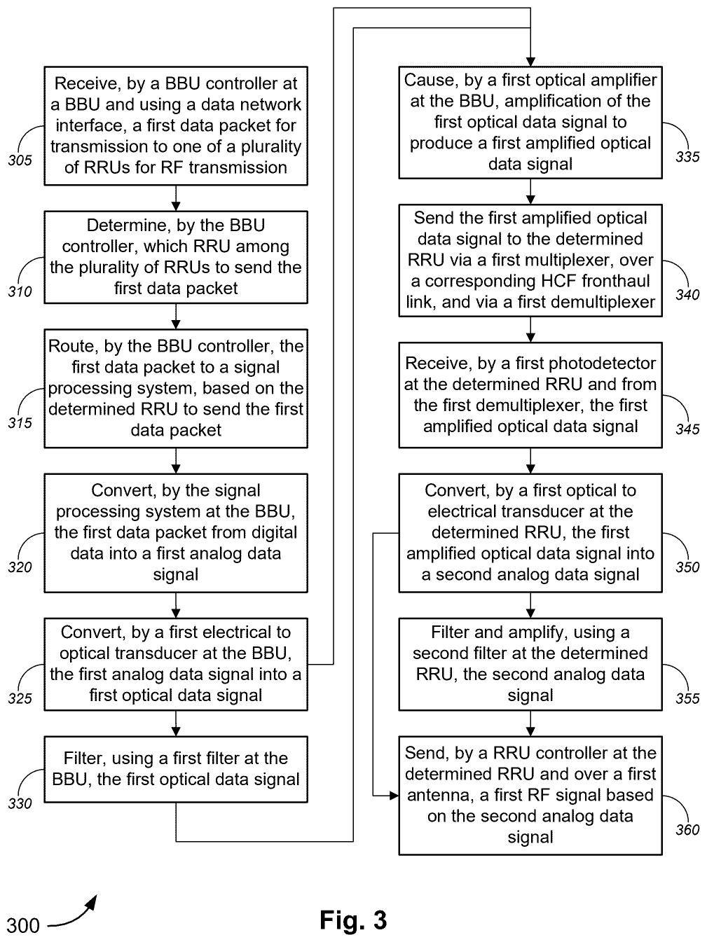

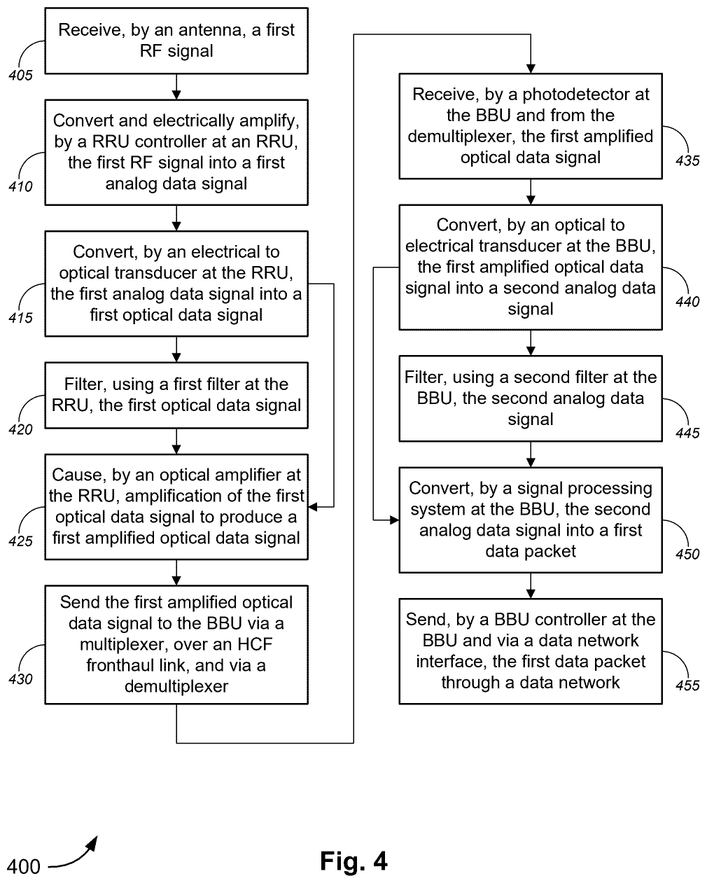

In operation, BBU 105 and RRU(s) 110a-110x and/or 115a-115x performs methods for implementing improved cellular fronthauling, as described in detail with respect to FIGS. 2A-4. For example, example sets of components 200A, 200B, and 200D as described below with respect to FIGS. 2A, 2B, and 2D, and example methods 300 and 400 as described below with respect to FIGS. 3 and 4, respectively, may be applied with respect to the operations of system 100 of FIG. 1.

In some aspects, at least one of BBU controller 122 and/or signal processing system(s) 130 receives a data packet from network(s) 120 via data network interface 128, and determines which RRU 110 among RRUs 110a-110x to send the data packet for RF transmission. In some cases, load balancer 124 is used when determining which RRU 110 to send the data packet. In the case that the BBU controller 122, rather than the signal processing system(s) 130, is used to receive the data packet and to determine which RRU 110 to send the data packet, the BBU controller 122 is further used to route the data packet to the signal processing system(s) 130. Based on a determination as to which RRU to send the data packet, the at least one of BBU controller 122 and/or signal processing system(s) 130 converts the data packet from digital data into a first analog data signal. The first analog data signal is converted by E/O transducer(s) 134 into a first optical control signal that is used to cause laser(s) 132 to generate a first optical data signal based on the first optical control signal. Optical amplifier(s) 136 amplifies the first optical data signal to produce analog optical data signal 138, which is multiplexed (with other analog optical data signals) and sent to the determined RRU 110 via a corresponding mux 140, a corresponding HCF fronthaul link 142, and a corresponding demux 144 that communicatively couple BBU 105 with the determined RRU 110. Alternatively, the first optical data signal is multiplexed (with other analog optical data signals), and each multiplexed analog optical data signal is amplified by optical amplifier 136′ to produce analog optical data signal 138, and the analog optical data signal 138 is sent to the determined RRU 110 via a corresponding HCF fronthaul link 142 and a corresponding demux 144 that communicatively couple BBU 105 with the determined RRU 110. With all of the optical connections between the BBU frontend and the HCF being either free space or hollow-core-based, nonlinearities caused by a solid core receiving optical signals that have been amplified above a threshold power are obviated, and there is no limitation as to how high the optical signals can be amplified for transmission through the HCF while avoiding nonlinearities. In an example, very high-power optical sources and a single high-power amplifier after the mux are used. In another example, optical signals from every optical source are amplified separately and then multiplexed together using a high-power mux, with connections made in free space or in HCF to withstand the high-power optical signals. After transmission through the corresponding HCF fronthaul link 142 and after demultiplexing by the corresponding demux 144, RRU 110 detects the analog optical data signal 138, which is subsequently converted by O/E transducer(s) 148 into a second analog data signal. RRU controller 146 causes filter and/or amplifier 152 to filter and amplify the second analog data signal, and causes antenna(s) 154 to transmit a first RF signal, over the air, based on the second analog data signal. In examples, the first RF signal is at its original wavelength up to a millimeter wave (“mmWave”) range (e.g., corresponding to a frequency of 60+ GHz or so), while the optical carrier signal for carrying the first RF signal is one of an original band (“O-band”) channel (at wavelengths between about 1260 and about 1360 nm), a conventional band (“C-band”) channel (at wavelengths between about 1530 and about 1565 nm), a long wavelength band (“L-band”) channel (at wavelengths between about 1565 and about 1625 nm), or any other band where the amplifier can operate (e.g., a 4G spectrum channel (at wavelengths between about 100 and about 400 nm), a 5G spectrum channel (at wavelengths between about 300 and about 1000 nm), or a millimeter wave (“mmWave”) channel (at wavelengths between about 1 and about 10 mm)).

In another aspect, an RRU 115 receives a second RF signal using antenna(s) 158. RRU controller 156 uses filter and/or amplifier 160 to filter and/or amplify the second RF signal, and the filtered second RF signal is used as input into laser(s) 162, in some cases, using E/O transducer(s) 164 to convey electrical signals onto an optical signal(s). The E/O transducer(s) 164 uses one of two modulation methods: (1) direct modulation of a laser(s), in which the current of the laser is modulated by the incoming analog signal; or (2) external modulation of the laser(s), where the output of the laser(s) is coupled to an external optical modulator, which is driven using a drive signal with the analog signal. Optical amplifier(s) 166 amplifies the second optical data signal to produce analog optical data signal 168, which is multiplexed and sent to the BBU 105 via a corresponding mux 170, a corresponding HCF fronthaul link 172, and a corresponding demux 174 that communicatively couple the BBU 105 and the RRU 115. Alternatively, the second optical data signal is multiplexed by a corresponding mux 170, and is amplified by optical amplifier(s) 166′ to produce analog optical data signal 168, and the analog optical data signal 168 is sent to the BBU 105 via a corresponding HCF fronthaul link 172 and a corresponding demux 174 that communicatively couple the BBU 105 and the RRU 115. After transmission through the corresponding HCF fronthaul link 172 and after demultiplexing by the corresponding demux 174, BBU 105 detects and converts the analog optical data signal 168 into a third analog data signal using O/E transducer(s) 176 (in some cases, including photodetector(s) 178), and filters the third analog data signal using filter(s) 180. BBU controller 122 causes signal processing system(s) 130 to convert the third analog data signal into a second data packet that is sent to the network(s) 120 via data network interface 128. In some examples, the signal processing system(s) 130 includes various sub-blocks. For the uplink to BBU, the various sub-blocks filter, down-convert, digitize, down-convert, then demodulate data signals, with bits and packets being subsequently extracted. For the downlink from the BBU to the RRU, only filtering and amplification occurs. In examples, an amplitude of the analog optical data signal 138 that is sent from the BBU 105 to the determined RRU 110 is greater than an amplitude of the analog optical data signal 168 that is sent from the RRU 115 to the BBU 105. This is due to a need to ensure sufficient energy for transmission over the air as an RF signal for the analog optical data signal 138 from the BBU 105 to the RRU 110, in contrast with conversion into a data packet, which has lower energy requirements (particularly if the O/E transducer(s) 176 and/or the photodetector(s) 178 is sufficiently sensitive), for the analog optical data signal 168 from the RRU 115 to the BBU 105.

In an example, BBU controller 122 causes signal processing system(s) 130 to convert a common clock signal from system clock 126 into a first analog clock signal. The BBU controller 122 further causes each E/O transducer 134 to convert the first analog clock signal into another clock control signal that is used by each corresponding laser 132 to generate an optical clock signal, which is amplified by each corresponding optical amplifier 136 (before muxes 140) or 136′ (after muxes 140). Alternative to using the signal processing system(s) 130, BBU controller 122 causes each E/O transducer 134 to convert the common clock signal directly into a clock control signal that is used by each corresponding laser 132 to generate the optical clock signal. In either case, the optical clock signal is sent to each of the RRUs 110a-110x and 115a-115x via corresponding muxes 140, corresponding HCF fronthaul links 142, and corresponding demuxes 144. The optical clock signal is received and converted by O/E transducer(s) 148 into yet another analog clock signal, which is converted by RRU controller 146 into a clock synchronization signal. In some examples, the O/E transducer(s) 148 includes (or is the same as) photodetector(s) 150. RRU controller 146 synchronizes a local clock using the clock synchronization signal.

FIGS. 2A-2C depict various example sets of components 200A and 200B that are used, and an example series of optical signals 200C that is sent as output of one of a plurality of muxes from a BBU to an RRU(s), when implementing improved cellular fronthauling. FIG. 2D depicts an example set of components 200D that is used for sending optical signals from an RRU to a BBU when implementing improved cellular fronthauling. In some embodiments, BBU 205, data network interface 210, synchronization signal/fault detection/monitoring systems 215a-215n and 215a′-215n′, BBU to RRU data transfer systems 220a-220z, feed to RRU systems 230, E/O—amplification systems 240, muxes 246a-246n, HCF fronthaul links 256 and 256a-256n, demuxes 252a-252n, RRUs 260a-260z, 265a-265z, 270a-270z, and 275a-275z, feed to BBU systems 262a-262z, 266a-266z, 272a-272z, and 276a-276z, E/O—amplification systems 264′ or 264a-264z, 268′ or 268a-268z, 274′ or 274a-274z, and 278′ or 278a-278z, muxes 254a-254n, HCF fronthaul links 258 and 258a-258n, demuxes 252a-252n, and O/E—amplification 232a′-232z′, 234a′-234z′, 236a′-236z′, and 240a′-240z′ of FIGS. 2A-2D may be similar, if not identical, to the BBU 105, data network interface 128, BBU controller 122/system clock 126, signal processing system(s) 130, laser(s) 132/E/O transducer(s) 134/optical amplifier(s) 136 or 136′, mux(es) 140, HCF fronthaul links 142, demux(es) 144, RRUs 110a-110x and 115a-115n, RRU controller 156/filter and/or amplifier 160, laser(s) 162/E/O transducer(s) 164/optical amplifier(s) 166 or 166′, muxes 170, HCF fronthaul links 172, demuxes 174, and O/E transducer(s) 176/photodetector(s) 178, respectively, of system 100 of FIG. 1, and the description of these components of system 100 of FIG. 1 are similarly applicable to the corresponding components of FIGS. 2A-2D. Herein, m, n, x, and z are non-negative integer numbers that may be either all the same as each other, all different from each other, or some combination of same and different (e.g., one set of two or more having the same values with the others having different values, a plurality of sets of two or more having the same value with the others having different values).

With reference to FIG. 2A, in an example, the example set of components 200A includes BBU 205, HCF fronthaul links 256a-256n (collectively, “HCF fronthaul links 256”), demuxes 252a-252n, and RRUs 260a-260z, 265a-265z, 270a-270z, and 275a-275z. In examples, in BBU 205, data network interface 210 communicatively couples a network(s) (e.g., network(s) 120 of FIG. 1) with each of feed to RRU systems 230 in BBU to RRU data transfer systems 220a-220z. The feed to RRU systems 230 include feed to RRU systems 222a-222z, 224a-224z, 226a-226z, through 230a-230z, each communicatively coupled to corresponding E/O—amplification systems 232′ or 232a-232z, 234′ or 234a-234z, 236′ or 236a-236z, through 240′ or 240a-240z (collectively, “E/O—amplification systems 240”). In examples, feed to RRU systems 230 each performs functions similar, if not identical, to signal processing system(s) 130 of FIG. 1, as described in detail above. The feed to RRU systems 222a-222z, 224a-224z, 226a-226z, through 230a-230z each communicatively couples with a corresponding one of the E/O—amplification systems 232a-232z, 234a-234z, 236a-236z, through 240a-240z. In some examples, E/O—amplification systems 232a-232z, 234a-234z, 236a-236z, through 240a-240z each performs functions similar, if not identical, to a combination of laser(s) 132, E/O transducer(s) 134, and/or optical amplifier(s) 136 or 136′ of FIG. 1, as described in detail above. The feed to RRU systems 230 and corresponding E/O—amplification systems 240 are grouped into a plurality of BBU to RRU data transfer systems 220a-220z. As shown in FIG. 2A, synchronization signal/fault detection/monitoring systems 215a-215n each communicatively coupled with one of muxes 246a-246n. Each of E/O—amplification systems 232a-232z communicatively couples with mux 246a, and each of E/O—amplification systems 234a-234z communicatively couples with mux 246b, while each of E/O—amplification systems 236a-236z communicatively couples with mux 246c, and each of E/O—amplification systems 240a-240z communicatively couples with mux 246n. Muxes 246a-246n communicatively couples with corresponding demuxes 252a-252n via corresponding HCF fronthaul links 256a-256n (collectively, “HCF fronthaul links 256”). Demux 252a communicatively couples with RRUs 260a-260z, and demux 252b communicatively couples with RRUs 265a-265z, while demux 252c communicatively couples with RRUs 270a-270z, and demux 252n communicatively couples with RRUs 275a-275z. In some cases, each of muxes 246a-246n outputs an analog optical signal into a corresponding one of optical amplifiers 232′, 234′, 236′, or 240′, which amplifies the analog optical signal prior to transmission over the corresponding HCF fronthaul links 256a-256n to a corresponding one of demuxes 252a-252n.

For ease of illustration, in FIG. 2A, different line types are used to depict:
(a) connection between E/O—amplification systems 232a-232z and RRUs 260a-260z via mux 246a, HCF fronthaul link 256a, and demux 252a (depicted by the solid lines);
(b) connection between E/O—amplification systems 234a-234z and RRUs 265a-265z via mux 246b, HCF fronthaul link 256b, and demux 252b (depicted by the long-dashed lines);
(c) connection between E/O—amplification systems 236a-236z and RRUs 270a-270z via mux 246c, HCF fronthaul link 256c, and demux 252c (depicted by the short-dashed lines); and
(d) connection between E/O—amplification systems 240a-240z and RRUs 275a-275z via mux 246n, HCF fronthaul link 256n, and demux 252n (depicted by the dotted lines).

Referring to FIG. 2B, in an example, the example set of components 200B includes a feed to RRU system 230 (e.g., corresponding to one of the feed to RRU systems 230 of FIG. 2A). Each feed to RRU system 230 includes a plurality of wireless service in-phase and quadrature (“I/Q”) channels 280a-280m each communicatively coupled to a corresponding one of mixing to RF/filtering/electrical amplification systems 285a-285m. Each I/Q channel 280a-280m carries an in-phase data signal and a quadrature data signal, which are amplitude-modulated sinusoidal signals (modulated using an I/Q modulator) that have the same frequency but a phase difference of 90°. When summed, the in-phase data signal and the quadrature data signal (collectively, “I/Q signal”) doubles the data sent. Each mixing to RF/filtering/electrical amplification system 285a-285m, which converts the I/Q signals into analog RF data signals, performs filtering, and performs amplification of filter analog RF data signals, communicatively couples with a power coupling/amplification/filtering system 290. The power coupling/amplification/filtering system 290 couples the amplified and filtered analog RF data signals from each of the mixing to RF/filtering/electrical amplification system 285a-285m of the feed to RRU system 230, then performs additional amplification and filtering. In examples, the output of the power coupling/amplification/filtering system 290 is input into the corresponding E/O—amplification system 240 of FIG. 2A.

Turning to FIG. 2C, an example series of optical signals 200C is sent as output of one of the plurality of muxes 246a-246n from the BBU 205 to an RRU among the RRUs 260a-260z, 265a-265z, 270a-270z, and 275a-275z. As shown in FIG. 2C, a synchronization signal 292 is followed by a plurality of optical carrier signals 294a-294y (collectively, “optical carrier signals 294”). Each optical carrier signal 294 is carried over an optical channel among a plurality of channels λ₁-λ_{y}. Each optical carrier signal 294 includes double-sideband modulation of optical data signals 1 through Z corresponding to data traffic received from each of E/O—amplification systems 232′ or 232a-232z, data traffic received from each of E/O—amplification systems 234′ or 234a-234z, data traffic received from each of E/O—amplification systems 236′ or 236a-236z, or data traffic received from each of E/O—amplification systems 240′ or 240a-240z. In the example of FIG. 2C, each optical data signal among signals 1 through Z is a double-sideband modulation of the optical data signals or double-sideband modulated optical data signals (as depicted in FIG. 2C by triangular-shaped bands on either side of arrows denoted 1, 2, 3, through Z). A double-sideband modulated signal in general can concurrently carry two separate amplitude modulated signals (e.g., RF signals that are modulated on the optical carrier at an RF frequency). In examples, double-sideband modulation is used for direct detection (e.g., using intensity of light). In some examples, the receiver and transmitter side modulation can be changed to have different flavors of such optical modulation for direct detection. Various such flavors include Optical Carrier+Single-sideband, in which the transmission side optical modulation is optimized to only have the optical carrier and one set of subcarriers 1-Z, with the mirror image removed. Alternatively, Coherent transmission and detection can be used, where intensity/phase and polarization are used (and, in some cases, optical modulation and reception are also changed). Herein, m, n, x, y, and Z or z are non-negative integer numbers that may be either all the same as each other, all different from each other, or some combination of same and different (e.g., one set of two or more having the same values with the others having different values, a plurality of sets of two or more having the same value with the others having different values). As used herein, double-sideband modulation or the double-sideband modulated optical data signals (as depicted in FIG. 2C) is characterized by a mirrored arrangement of a sequence of optical data signal among signals 1 through Z on one side of a center wavelength of each channel λ and a reverse sequence of optical data signal among signals Z through 1 on the other side of the center wavelength of that channel λ. In examples, direct modulation is used that creates a double-sideband signal. In some cases, a different modulation (e.g., a different implementation of external modulation) is used to create only a single-sideband. As shown in FIG. 2C, in some examples, a fault detection signal 296 and a line monitoring signal 298 follow the plurality of optical carrier signals 294a-294y. Where the synchronization signal 292 is used to synchronize the RRUs (as described above), the fault detection signal 296 is used as a trigger for fault detection systems at the RRUs, in a technique referred to as reflectometry. Like optical frequency domain reflectometry (“OFDR”) or optical time domain reflectometry (“OTDR”), a signal is launched at the BBU side. If there are defects in the particular optical link, a reflection at the same transmitted wavelength is received, which assists with determining where the link is/was broken or damaged. In other words, upon detection of a fault, a corresponding error signal is returned to the BBU (e.g., to synchronization/fault detection/line monitoring systems 215a′-215n′ of FIG. 2D) from the RRU where the fault occurs. The line monitoring signal 298 likewise is used as a trigger for line monitoring between the BBU and the corresponding RRU. Upon detection of a line fault, a corresponding error signal is returned to the BBU.

With reference to FIG. 2D, in an example, the example set of components 200D includes RRUs 260a-260z, 265a-265z, 270a-270z, and 275a-275z and BBU 205, each corresponding to RRUs 260a-260z, 265a-265z, 270a-270z, and 275a-275z and BBU 205 of FIG. 2A. The example set of components 200D further includes muxes 254a-254n and HCF fronthaul links 258a-258n (collectively, “HCF fronthaul links 258”). As shown in FIG. 2D, each of RRUs 260a-260z includes a corresponding one of feed to BBU systems 262a-262z and a corresponding one of E/O—amplification systems 264a-264z, each such feed to BBU system 262 being communicatively coupled with the corresponding E/O—amplification system 264. Similarly, each of RRUs 265a-265z includes a corresponding one of feed to BBU systems 266a-266z and a corresponding one of E/O—amplification systems 268a-268z, each such feed to BBU system 266 being communicatively coupled with the corresponding E/O—amplification system 268. Likewise, each of RRUs 270a-270z includes a corresponding one of feed to BBU systems 272a-272z and a corresponding one of E/O—amplification systems 274a-274z, each such feed to BBU system 272 being communicatively coupled with the corresponding E/O—amplification system 274. Similarly, each of RRUs 275a-275z includes a corresponding one of feed to BBU systems 276a-276z and a corresponding one of E/O—amplification systems 278a-278z, each such feed to BBU system 276 being communicatively coupled with the corresponding E/O—amplification system 278.

BBU 205 further includes demuxes 248a-248n, synchronization signal/fault detection/monitoring systems 215a′-215n′, and O/E—amplification 232a′-232z′, 234a′-234z′, 236a′-236z′, and 240a′-240z′. Each of RRUs 260a-260z communicatively couples with mux 254a, and each of RRUs 265a-265z communicatively couples with mux 254b, while each of RRUs 270a-270z communicatively couples with mux 254c, and each of RRUs 275a-275z communicatively couples with mux 254n. Muxes 254a-254n communicatively couples with corresponding demuxes 248a-248n via corresponding HCF fronthaul links 258a-258n. In some cases, optical amplifiers 264′, 268′, 274′, or 278′each amplifies signals from a corresponding one of the muxes 254a-254n prior to transmission over a corresponding one of the HCF fronthaul links 258a-258n to a corresponding one of demuxes 248a-248n. Demux 248a communicatively couples with O/E—amplification 232a′-232z′, and demux 248b communicatively couples with O/E—amplification 234a′-234z′, while demux 248c communicatively couples with O/E—amplification 236a′-236z′, and demux 248n communicatively couples with O/E—amplification 240a′-240z′. Each of demuxes 248a-248n further communicatively couples with a corresponding one of synchronization signal/fault detection/monitoring systems 215a′-215n′.

In examples, with reference to FIGS. 2A-2D, the operations of the BBU 205 (and its components), the RRUs 260a-260z, 265a-265z, 270a-270z, and 275a-275z (and their components), the muxes 246a-246n and 254a-254n, the demuxes 248a-248n and 252a-252n, and the HCF fronthaul links 256a-256n and 258a-258n are otherwise similar to corresponding components of FIG. 1 in terms of structure and function.

With reference to FIG. 3, the operations of example method 300 may be performed by a BBU (e.g., BBUs 105 and 205 of FIGS. 1 and 2A) and an RRU(s) (e.g., RRUs 110, 260a-260z, 265a-265z, 270a-270z, and 275a-275z of FIGS. 1 and 2A). Referring to FIG. 4, the operations of example method 400 may be performed by a BBU (e.g., BBUs 105 and 205 of FIGS. 1 and 2D) and an RRU (e.g., RRUs 115, 260a-260z, 265a-265z, 270a-270z, and 275a-275z of FIGS. 1 and 2D).

FIG. 3 depicts an example method 300 for sending data from a BBU to an RRU among a plurality of RRUs when implementing improved cellular fronthauling. In the example of FIG. 3A, method 300, at operation 305, includes a BBU controller at the BBU receiving a first data packet for transmission to one of the plurality of RRUs for RF transmission, using a data network interface. In some cases, the BBU controller receives multiple streams dedicated to various RRUs, and the BBU controller manages and directs each stream to its corresponding RRU. At operation 310, the BBU controller determines which RRU among the plurality of RRUs to send the first data packet. The BBU controller routes the first data packet to a signal processing system of the BBU, based on the determined RRU to send the first data packet (at operation 315). At operation 320, the signal processing system converts the first data packet from digital data into a first analog data signal. A first electrical to optical transducer of the BBU converts the first analog data signal into a first optical data signal (at operation 325). In some examples, converting the first analog data signal into the first optical data signal (at operation 325) includes the first electrical to optical transducer converting the first analog data signal into a first optical control signal; and a first laser at the BBU generating the first optical data signal based on the first optical control signal. In examples, method 300 either continues onto the process at operation 330 or continues onto the process at operation 335. At operation 330, method 300 further includes a first filter at the BBU filtering the first optical data signal. Method 300 continues onto the process at operation 335. At operation 335, a first optical amplifier at the BBU causes amplification of the first optical data signal to produce a first amplified optical data signal. Method 300, at operation 340, the first amplified optical data signal is sent to the determined RRU via a first multiplexer, over a corresponding HCF fronthaul link among a plurality of HCF-based fronthaul links, and via a first demultiplexer. In some examples, rather than the filtering step at operation 330, the first multiplexer (at operation 340) adds a filter profile that is used to filter the first optical data signal. In examples, the first optical amplifier is disposed after the first multiplexer, and amplification of the first optical data signal occurs after being multiplexed by the first multiplexer.

At operation 345, a first photodetector at the determined RRU receives the first amplified optical data signal, from the first demultiplexer. The first optical to electrical transducer at the RRU converts the first amplified optical data signal into a second analog data signal (at operation 350). In examples, method 300 either continues onto the process at operation 355 or continues onto the process at operation 360. At operation 355, method 300 further includes a second filter at the RRU filtering (and amplifying) the second analog data signal. Method 300 continues onto the process at operation 360. At operation 360, the RRU controller at the RRU sends, over the first antenna, a first RF signal based on the second analog data signal.

FIG. 4 depicts an example method 400 for sending data from an RRU to a BBU when implementing improved cellular fronthauling. In the example of FIG. 4A, method 400, at operation 405, includes an antenna of the RRU receiving a first RF signal. At operation 410, an RRU controller of the RRU converts (and electrically amplifies) the first RF signal into a first analog data signal. An electrical to optical transducer of the RRU converts the first analog data signal into a first optical data signal (operation 415). In some examples, converting the first analog data signal into the first optical data signal (at operation 415) includes the electrical to optical transducer of the RRU converting the first analog data signal into a first optical control signal; and a laser at the RRU generating the first optical data signal based on the first optical control signal. In examples, method 400 either continues onto the process at operation 420 or continues onto the process at operation 425. At operation 420, method 400 further includes a filter at the RRU filtering the first optical data signal. Method 400 continues onto the process at operation 425. At operation 425, an optical amplifier of the RRU causes amplification of the first optical data signal to produce a first amplified optical data signal. Method 400, at operation 430, the first amplified optical data signal is sent to the BBU via a multiplexer among a plurality of multiplexers, over an HCF fronthaul link among a plurality of HCF-based fronthaul links, and via a demultiplexer among a plurality of demultiplexers. In some examples, rather than the filtering step at operation 420, the multiplexer (at operation 430) adds a filter profile that is used to filter the first optical data signal. In examples, the optical amplifier is disposed after the multiplexer, and amplification of the first optical data signal occurs after being multiplexed by the multiplexer. Method 400 continues onto the process at operation 435. Here, the first optical data signal can be amplified to a high level of amplification. As HCF does not have any issues with high-power transmission, amplification can be as high as possible. In an example, high-power lasers can be used that are modulated and then multiplexed, and the multiplexed signal is then amplified to very high powers (e.g., 34+ dBm or greater). In another example, each individual optical signal is amplified before the mux after the modulation stage with a separate amplifier, raising the transmission power (e.g., to 30-34+ dBm), then multiplexing all of the amplified optical signals. In either example, the line system (e.g., amplification and mux) can be performed in HCF or in free space.

At operation 435, a photodetector among a plurality of photodetectors at the BBU receives the first amplified optical data signal from the demultiplexer. Because high-power optical signals are being transmitted, the plurality of photodetectors includes high-power photodetectors that are capable of receiving the high-power optical signals and generating high-power electrical RF signals. An optical to electrical transducer among a plurality of optical to electrical transducers at the BBU converts the first amplified optical data signal into a second analog data signal (at operation 440). In examples, method 400 either continues onto the process at operation 445 or continues onto the process at operation 450. At operation 445, method 400 further includes a second filter at the BBU filtering the second analog data signal. Method 400 continues onto the process at operation 450. At operation 450, a signal processing system among the plurality of signal processing systems at the BBU converts the second analog data signal into a first data packet. A BBU controller at the BBU sends the first data packet through a data network, via a data network interface at the BBU (at operation 455).

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200A-200D of FIGS. 1 and 2A-2D, respectively (or components thereof), such methods may also be implemented using any suitable hardware (or software) implementation. Similarly, while each of the systems, examples, or embodiments 100 and 200A-200D of FIGS. 1 and 2A-2D, respectively (or components thereof), can operate according to the methods 300, 400 (e.g., by executing instructions embodied on a computer readable medium), the systems, examples, or embodiments 100 and 200A-200D of FIGS. 1 and 2A-2D can each also operate according to other modes of operation and/or perform other suitable procedures.

As should be appreciated from the foregoing, the present technology provides multiple technical benefits and solutions to technical problems. For instance, implementing RAN or C-RAN (or O-RAN) using conventional infrastructure (e.g., using solid core fiber-based systems) generally raises multiple technical problems. For example, one technical problem is that such conventional infrastructure requires analog microwave signals to be digitized for transport over fronthaul links, because normal solid core optical fibers otherwise induce distortions such as fading effects and the generation of spurious signals that are detrimental to quality of the microwave signals. The digitization process involves a significant multiplication in the effective payload data rates, which can sometimes require base stations needing fiber delivery of data rates on the order of 10s to 100s of Terabits per second, and potentially Petabits per second for next generation systems. As a consequence, greater complexity is required for the hardware and software, as well as greater power consumption. Synchronization is also made difficult due to solid core fibers being susceptible to stretching caused by temperature variations and stresses, which in turn causes changes in refractive index over time that results in changes in delay over time being different for different fibers. Further, for C-RAN systems, there is a latency range that needs to be adhered to which will reduce the maximum distance between RRU and RRH, but for solid core fibers, the latency is higher than for HCF.

The present technology provides for a low complexity and low latency implementation for cellular fronthauling. At a BBU, data packets received from a data network are converted into analog data signals, which are in turn converted into analog optical signals that are optically amplified and sent over an HCF-based fronthaul link(s) to an RRU(s). At the RRU(s), the analog optical signals are converted into analog data signals that are sent over the air as RF signals via an antenna(s). In some cases, the analog data signals are filtered and amplified prior to transmission as RF signals. RF signals that are received, via antennas, at an RRU are conversely filtered and converted into analog optical signals, transmitted over the HCF-based fronthaul link(s) to the BBU, where the analog optical signals are converted into data packets for transmission over the data network. In this manner, digitization of the optical data signal and back to analog after transmission over the fronthaul link is obviated. High-power or high intensity optical signals can also be sent over the HCF-based fronthaul link(s) compared with solid core fiber-based fronthaul links, which are susceptible to chromatic dispersion and nonlinearities due to interaction between high intensity propagating optical signals and silica in the solid core fibers. This is due to the structure of HCFs minimizing Kerr effects, thus minimizing chromatic dispersion and nonlinearities. Further, the reduced latency with the use of HCF allows for further distances between the RRU and the RRH. Overall, the present technology results in energy savings, reduced hardware requirements, enhanced reliability, reduced error rates, low complexity, and low latency.

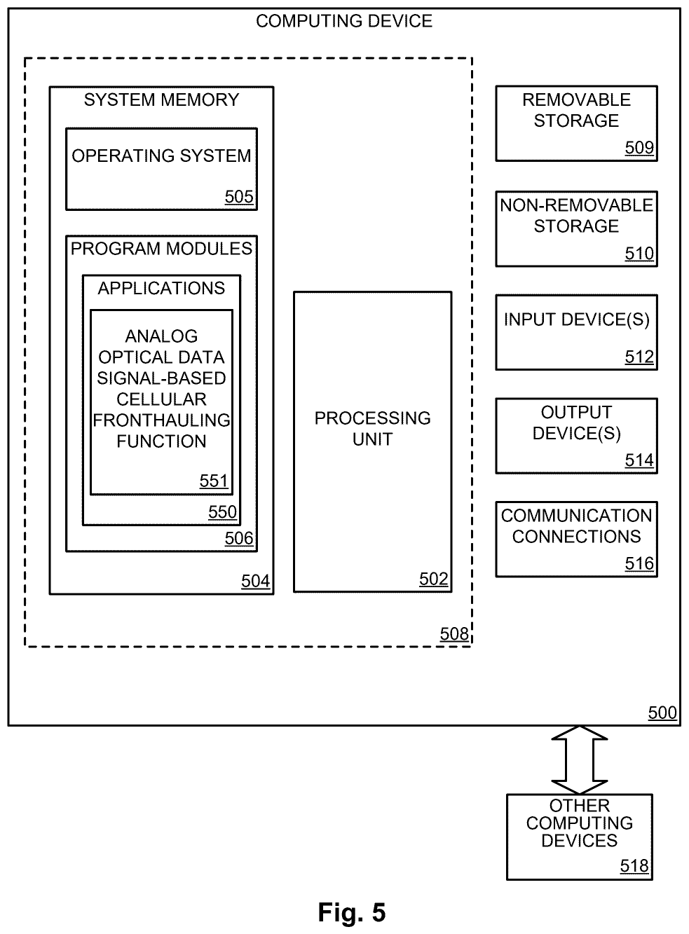

FIG. 5 depicts a block diagram illustrating physical components (i.e., hardware) of a computing device 500 with which examples of the present disclosure may be practiced. The computing device components described below may be suitable for a client device implementing the improved cellular fronthauling, as discussed above. In a basic configuration, the computing device 500 may include at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as analog optical data signal-based cellular fronthauling function 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit 502, the program modules 506 may perform processes including one or more of the operations of the method(s) as illustrated in FIGS. 3 and 4, or one or more operations of the system(s) and/or apparatus(es) as described with respect to FIGS. 1-2D, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include RF transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system for implementing improved cellular fronthauling, the system comprising:
a baseband unit (“BBU”) comprising a BBU controller, a data network interface, a signal processing system, a first electrical to optical transducer, a first laser, a first optical amplifier, and a first multiplexer;
a first demultiplexer;
a plurality of remote radio units (“RRUs”) each comprising a RRU controller, a first photodetector, a first optical to electrical transducer, and a first antenna; and
a plurality of hollow core fiber (“HCF”)-based fronthaul links each established between the first multiplexer and the first demultiplexer;
wherein the BBU performs first operations comprising:
receiving, by the BBU controller and using the data network interface, a first data packet for transmission to one of the plurality of RRUs for radio frequency (“RF”) transmission;
determining, by the BBU controller, which RRU among the plurality of RRUs to send the first data packet;
routing, by the BBU controller, the first data packet to the signal processing system, based on the determined RRU to send the first data packet;
converting, by the signal processing system, the first data packet from digital data into a first analog data signal;
converting, by the first electrical to optical transducer, the first analog data signal into a first optical control signal;
generating, by the first laser, a first optical data signal based on the first optical control signal;
causing, by the first optical amplifier, amplification of the first optical data signal to produce a first amplified optical data signal; and
sending the first amplified optical data signal to the determined RRU via the first multiplexer, over a corresponding HCF fronthaul link among the plurality of HCF-based fronthaul links, and via the first demultiplexer;
wherein each RRU performs second operations comprising:
receiving, by the first photodetector and from the first demultiplexer, the first amplified optical data signal;
converting, by the first optical to electrical transducer, the first amplified optical data signal into a second analog data signal; and
sending, by the RRU controller and over the first antenna, a first RF signal based on the second analog data signal.

2. The system of claim 1, wherein the BBU further comprises a system clock,
wherein the first operations further comprise:
converting, by the signal processing system, a common clock signal produced by the system clock into a first analog clock signal;
converting, by the first electrical to optical transducer, the first analog clock signal into a second optical control signal;
generating, by the first laser, a first optical clock signal based on the second optical control signal;
causing, by the first optical amplifier, amplification of the first optical clock signal to produce a first amplified optical clock signal; and
sending the first amplified optical clock signal to the plurality of RRUs via the first multiplexer, over the plurality of HCF-based fronthaul links, and via the first demultiplexer.

3. The system of claim 2, wherein each RRU further comprises a local clock,
wherein the second operations further comprise:
receiving, by the first photodetector and from the first demultiplexer, the first amplified optical clock signal;
converting, by the first optical to electrical transducer, the first amplified optical clock signal into a second analog clock signal;
converting, by the RRU controller, the second analog clock signal into a clock synchronization signal; and
synchronizing, by the RRU controller, the local clock using the clock synchronization signal.

4. The system of claim 1, further comprising a second multiplexer, wherein each RRU further comprises a second optical amplifiers, a second laser, a second electrical to optical transducer, and a second antenna, wherein the BBU further comprises a second demultiplexer,
wherein one of the RRUs performs third operations comprising:
receiving, by the second antenna, a second RF signal;
converting, by the RRU controller, the second RF signal into a third analog data signal;
converting, by the second electrical to optical transducer, the third analog data signal into a third optical control signal;
generating, by the second laser, a second optical data signal based on the third optical control signal;
causing, by the second optical amplifier, amplification of the second optical data signal to produce a second amplified optical data signal; and
sending the second amplified optical data signal to the BBU via a second multiplexer, over one of the corresponding HCF fronthaul link or another HCF fronthaul link among the plurality of HCF-based fronthaul links, and via a second demultiplexer.

5. The system of claim 4, wherein the BBU further comprises a second optical to electrical transducer and a second photodetector,
wherein the first operations further comprise:
receiving, by a second photodetector and from the second demultiplexer, the second amplified optical data signal;
converting, by a second optical to electrical transducer, the second amplified optical data signal into a fourth analog data signal;
converting, by a second signal processing system, the fourth analog data signal into a second data packet; and
sending, by the BBU controller and via the data network interface, the second data packet through a data network.

6. The system of claim 4, wherein an amplitude of the first amplified optical data signal that is sent from the BBU to the determined RRU is greater than an amplitude of the second amplified optical data signal that is sent from the one of the RRUs to the BBU.

7. The system of claim 1, wherein the first RF signal is sent over one of a thousand band (“T-band”) channel, an original band (“O-band”) channel, a conventional band (“C-band”) channel, a long wavelength band (“L-band”) channel, a 4G spectrum channel, a 5G spectrum channel, or a millimeter wave (“mmWave”) channel.

8. The system of claim 1,
wherein the first operations further comprise:
receiving, by the BBU controller and using the data network interface, a third data packet and a fourth data packet for transmission to the one of the plurality of RRUs;
converting, by the corresponding signal processing system, the third data packet and the fourth data packet into in-phase and quadrature (“I/Q”) analog data signals, respectively;
converting, by the corresponding first electrical to optical transducer, the I/Q analog data signals into I/Q optical control signals;
generating, by the corresponding first laser, I/Q optical data signals based on the I/Q optical control signals;
causing, by the corresponding first optical amplifier, amplification of the I/Q optical data signal to produce amplified I/Q optical data signals; and
sending the amplified I/Q optical data signal to the determined RRU via the corresponding first multiplexer, over the corresponding HCF fronthaul link, and via the corresponding first demultiplexer.

9. The system of claim 1, wherein the BBU further comprises a first filter,
wherein the first operations further comprise:
filtering, using the first filter, the first optical data signal prior to amplification by the corresponding first optical amplifier.

10. The system of claim 1, wherein each RRU further comprises a second filter,
wherein the second operations further comprise:
filtering, using the second filter, the second analog data signal prior to sending the first RF signal.

11. A computer-implemented method for implementing improved cellular fronthauling, the method comprising:
converting, by a baseband unit (“BBU”) controller at a BBU, a first data packet into a first analog data signal
converting, by a first electrical to optical transducer at the BBU, the first analog data signal into a first optical data signal;
causing, by a first optical amplifier at the BBU, amplification of the first optical data signal to produce a first amplified optical data signal;
sending the first amplified optical data signal to a remote radio unit (“RRU”) via a first multiplexer, over a hollow core fiber (“HCF”)-based fronthaul link, and via a first demultiplexer;
receiving, by a first photodetector at the RRU, the first amplified optical data signal;
converting, by a first optical to electrical transducer at the RRU, the first amplified optical data signal into a second analog data signal; and
sending, by an RRU controller and over a first antenna at the RRU, a first radio frequency (“RF”) signal based on the second analog data signal.

12. The computer-implemented method of claim 11, further comprising:
receiving, by a second antenna at the RRU, a second RF signal;
converting, by the RRU controller, the second RF signal into a third analog data signal;
converting, by a second electrical to optical transducer at the RRU, the third analog data signal into a second optical data signal;
causing, by a second optical amplifier at the RRU, amplification of the second optical data signal to produce a second amplified optical data signal; and
sending the second amplified optical data signal to the BBU via a second multiplexer, over one of the HCF-based fronthaul link or another HCF-based fronthaul link, and via a second demultiplexer;
receiving, by a second photodetector at the BBU and from the second demultiplexer, the second amplified optical data signal;
converting, by a second optical to electrical transducer at the BBU, the second amplified optical data signal into a fourth analog data signal;
converting, by the BBU controller, the fourth analog data signal into a second data packet; and
sending, by the BBU controller and via a data network interface, the second data packet through a data network.

13. The computer-implemented method of claim 12, wherein an amplitude of the first amplified optical data signal that is sent from the BBU to the RRU is greater than an amplitude of the second amplified optical data signal that is sent from the RRU to the BBU.

14. The computer-implemented method of claim 12, wherein the first analog data signal and the third analog data signals are each converted into at least one of a double-sideband modulated data signal or in-phase and quadrature (“I/Q”) analog data signals prior to transmission over corresponding HCF-based fronthaul link from the BBU and to the BBU, respectively.

15. A system, comprising:
a plurality of remote radio units (“RRUs”) each comprising a RRU controller, an optical amplifier, a laser, an electrical to optical transducer, and an antenna;
a plurality of multiplexers;
a baseband unit (“BBU”) comprising a BBU controller, a data network interface, a plurality of signal processing systems, a plurality of optical to electrical transducers, a plurality of photodetectors, and a plurality of demultiplexers; and
a plurality of hollow core fiber (“HCF”)-based fronthaul links each established between one of the plurality of multiplexers and one of the plurality of demultiplexers;
wherein a first RRU among the plurality of RRUs performs first operations comprising:
receiving, by the antenna, a first radio frequency (“RF”) signal;
converting, by the RRU controller, the first RF signal into a first analog data signal;
converting, by the electrical to optical transducer, the first analog data signal into a first optical control signal;
generating, by the laser, a first optical data signal based on the first optical control signal;
causing, by the optical amplifier, amplification of the first optical data signal to produce a first amplified optical data signal; and
sending the first amplified optical data signal to the BBU via a multiplexer among the plurality of multiplexers, over an HCF fronthaul link among the plurality of HCF-based fronthaul links, and via a demultiplexer among the plurality of demultiplexers;
wherein the BBU performs second operations comprising:
receiving, by a photodetector among the plurality of photodetectors and from the demultiplexer, the first amplified optical data signal;
converting, by an optical to electrical transducer among the plurality of optical to electrical transducers, the first amplified optical data signal into a second analog data signal;
converting, by a signal processing system among the plurality of signal processing systems, the second analog data signal into a first data packet; and
sending, by the BBU controller and via the data network interface, the first data packet through a data network.

16. The system of claim 15, wherein the first RF signal is received over one of a thousand band (“T-band”) channel, an original band (“O-band”) channel, a conventional band (“C-band”) channel, a long wavelength band (“L-band”) channel, a 4G spectrum channel, a 5G spectrum channel, or a millimeter wave (“mmWave”) channel.

17. The system of claim 15, wherein the first analog data signal is converted into in-phase and quadrature (“I/Q”) analog data signals that are converted into I/Q optical data signals that are transmitted over I/Q channels over the HCF fronthaul link to the BBU.

18. The system of claim 15, wherein the first analog data signal is converted into a double-sideband modulated data signal.

19. The system of claim 15, wherein each RRU further comprises a first filter,
wherein the first operations further comprise:
filtering, using the first filter, the first optical data signal prior to amplification by the optical amplifier.

20. The system of claim 15, wherein the BBU further comprises a plurality of second filters,
wherein the second operations further comprise:
filtering, using a corresponding second filter among the plurality of second filters, the second analog data signal prior to conversion into the first data packet.
